(19) United States
(12) Patent Application Publication
(10) Pub. No.: US 2019/0317523 A1
(43) Pub. Date: Oct. 17, 2019

(54) HIGHWAY SYSTEM FOR AUTONOMOUS VEHICLES

(71) Applicant: Hay Yeung Cheung, West Orange, NJ (US)

(72) Inventor: Hay Yeung Cheung, West Orange, NJ (US)

(21) Appl. No.: 16/371,236

(22) Filed: Apr. 1, 2019

Related U.S. Application Data
(60) Provisional application No. 62/658,005, filed on Apr. 16, 2018.

(51) Int. Cl. G05D 1/02; G08G 1/0967; G08G 1/01

(52) U.S. Cl. CPC G05D 1/0297; G08G 1/096725; G05D 2201/0213; G08G 1/0145; G05D 1/0285; G08G 1/096775

(57) ABSTRACT

A highway system including: a stretch of highway that includes one or more lanes, and each lane being divided into a plurality of fixed size slots; a plurality of vehicles traveling on the highway at a system specified speed; and a control system configured to control the plurality of vehicles by sending commands to the plurality of vehicles via a wireless communication system; wherein the control system is configured to divide time into timeslots based on the system specified speed and the size of the slots, such that each vehicle is assigned to occupy a slot during a timeslot; wherein each of the plurality of vehicles includes a processor configured to receive a command from the control system and to control its associated vehicle according to the command.

### CROSS REFERENCE TO RELATED APPLICATIONS

This application claims the benefit of U.S. Provisional Application No. 62/658,005, filed on Apr. 16, 2018. The entire contents of U.S. Provisional Application No. 62/658,005 are hereby incorporated by reference.

### FIELD OF THE INVENTION

The invention generally relates to transportation systems. More particularly, the invention relates to a highway system for autonomous vehicles.

### BACKGROUND

In road traffic, vehicles follow one after another in a lane, and typically there are decelerations and accelerations of the vehicles. The accordion effect, or slinky effect, refers to the decelerations and accelerations of a vehicle in response to the vehicle in front that decelerates and accelerates. These fluctuations in speed propagate backwards and typically get bigger and bigger further down the line, decreasing the throughput of road traffic.

According to Wikipedia, the accordion effect occurs when fluctuations in the motion of a travelling body causes disruptions in the flow of elements following it. This can happen in road traffic, foot marching, bicycle racing, and, in general, to processes in a pipeline. These are examples of nonlinear processes. The accordion effect generally decreases the throughput of the system in which it occurs.

A reason for this problem is that humans are not perfect drivers and they often drive too fast, too slow or erratically. As a result, the cars they drive may fail to maintain a proper speed or stay in lane. When this happens, other drivers react to this situation in order to avoid collisions. However, it takes time for a human to react to a change in condition, and the reaction time gets to accumulate down the line.

To illustrate the accordion effect, consider a simple example: There are 10 vehicles stopped behind a red traffic light. When the traffic light turns green, the driver in the first vehicle releases the brake and applies the gas; seeing the vehicle in front move, the driver in the second vehicle releases the brake and applies the gas after a short reaction time; seeing the vehicle in front move, the driver in the third vehicle releases the brake and applies the gas after another short reaction time; as so on. By the time the driver in the tenth vehicle reacts, all these reaction times already add up to a substantial delay. If the average reaction time is 0.5 seconds, the tenth vehicle would be delayed by 5 seconds. This effect substantially reduces the traffic throughput. Thus, there is need for eliminating the accordion effect in road traffic.

With the recent advent of autonomous vehicle, it is possible to drive a vehicle without a human operator. So far, these autonomous vehicles are individually controlled based on location and proximity sensors and signals to navigate in the traffic and avoid collisions. To solve the above problems, the present invention proposes to take the human factor out of driving and further to take the control of autonomous vehicles under a control command when these vehicles are traveling in a highway system according to various embodiments below.

### SUMMARY

One embodiment of the present invention provides a highway system including: a stretch of highway that includes one or more lanes, and each lane being divided into a plurality of fixed size slots; a plurality of vehicles traveling on the highway at a system specified speed; and a control system configured to control the plurality of vehicles by sending commands to the plurality of vehicles via a wireless communication system; wherein the control system is configured to divide time into timeslots based on the system specified speed and the size of the slots, such that each vehicle is assigned to occupy a slot during a timeslot; wherein each of the plurality of vehicles includes a processor configured to receive a command from the control system and to control its associated vehicle according to the command.

One embodiment of the present invention provides a method of managing a highway system that comprises one or more lanes, the method including: dividing each of the one or more lanes into a plurality of fixed size slots; controlling a plurality of vehicles traveling on the highway at a system specified speed; and dividing a system time into timeslots based on the system specified speed and the size of the slots, such that each vehicle is assigned to occupy a slot in the highway during a timeslot; transmitting a control command to a processor in each of the plurality of vehicles via a wireless communication system so that the processor controls its associated vehicle according to the command.

### BRIEF DESCRIPTION OF THE DRAWINGS

FIG. 1 is a schematic drawing of a highway system in accordance with an embodiment.

FIG. 2 is a drawing of a car in a slot with dimensions in accordance with an embodiment.

FIG. 3 illustrates the vehicle movement between slots in accordance with an embodiment.

FIG. 4 illustrates the relationship between slot occupancy and time in accordance with an embodiment.

FIG. 5 illustrates a worldline of a vehicle in accordance with an embodiment.

FIG. 6 illustrates a world-band of a vehicle in accordance with an embodiment.

FIG. 7 illustrates worldlines of vehicles in accordance with an embodiment.

FIG. 8 illustrates worldlines of vehicles that involve in a collision in accordance with an embodiment.

FIG. 9 illustrates worldlines of vehicles in accordance with an embodiment.

FIG. 10 illustrates worldlines of vehicles that involve in a collision in accordance with an embodiment.

FIG. 11 illustrates the movement of an empty slot in accordance with an embodiment.

FIG. 12 illustrates the highway entrance process in accordance with an embodiment.

FIG. 13 illustrates an entrance loop in accordance with an embodiment.

FIG. 14 illustrates the horizontal movement for lane change in accordance with an embodiment.

FIG. 15 illustrates the speed components for lane change in accordance with an embodiment.

FIG. 16 illustrates a slot advance process in accordance with an embodiment.

FIG. 17 illustrates a slot fall back process in accordance with an embodiment.

FIG. 18 is a schematic drawing of the topology of a highway system in accordance with an embodiment.

FIG. 19 illustrates a lane staggering configuration in accordance with an embodiment.

FIG. 20 illustrates the lane merging in accordance with an embodiment.

FIGS. 21A-21D illustrate an example of the traffic crossing in accordance with an embodiment.

FIG. 22 illustrates a traffic control at an intersection in accordance with an embodiment.

FIG. 23 illustrates a traffic control at intersections in accordance with an embodiment.

FIG. 24 illustrates a traffic control at intersections in accordance with an embodiment.

FIG. 25 illustrate the accommodation of an emergency vehicle in accordance with an embodiment.

FIG. 26 is a plot of occupancy rate as a function of available slots for traffic entry in accordance with an embodiment.

FIG. 27 is the probability of no wait at the entrance ramp as a function of available slots for traffic entry in accordance with an embodiment.

FIG. 28 shows the optimal number of available slots for traffic entry based on a quality model according to an embodiment.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

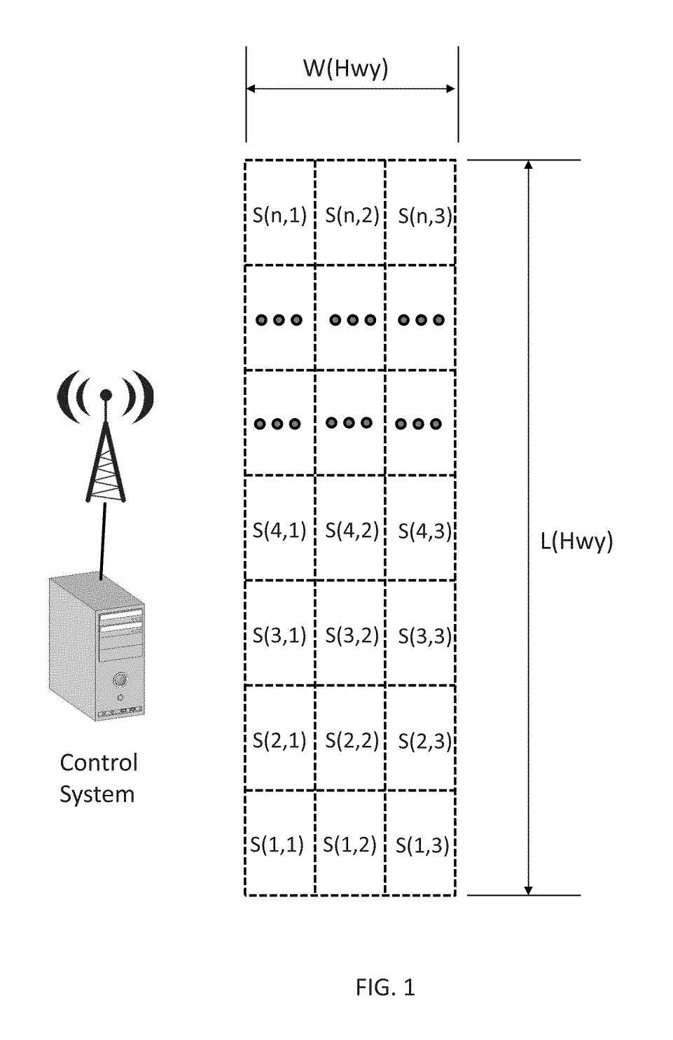

FIG. 1 shows a stretch of highway that has a width W(Hwy) and a length L(Hwy). FIG. 1 also shows a control system coupled to a communications system. It is understood that the control system includes a processor coupled to a memory configured to perform the control functions described herein. The highway is divided into multiple lanes and each lane is divided into multiple slots. For example, the highway is divided into 3 lanes, and in each lane n slots. Each slot is then identified as S(i, j), where i=lane number, i runs from 1 to 3, and j=slot number, j runs from 1 to n.

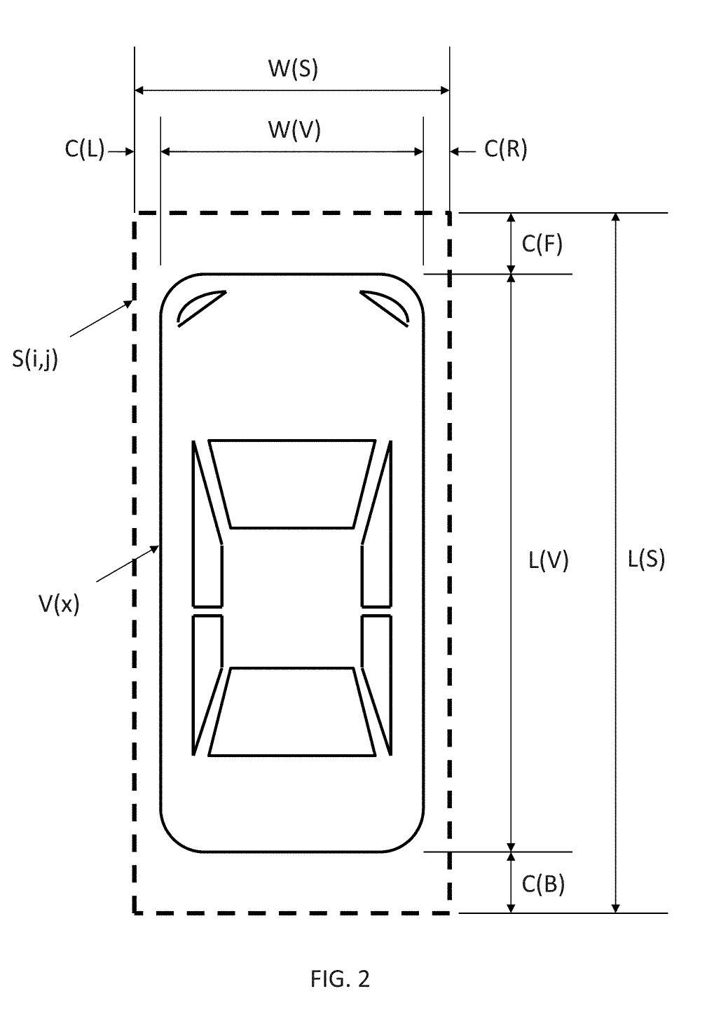

FIG. 2 shows that each slot S(i, j) has a width W(S) and a length L(S). Each of the slots may be occupied by a vehicle V(x), where x is an identifier of the vehicle, e.g., serial number, VIN or IPV6 address, etc. The VIN may be preferred not only because it uniquely identifies the vehicle but also gives the control system information about the physical characteristics of the vehicles, such as dimensions, horsepower, communications, and other capabilities that are necessary for the control system to control and manage the vehicle. As shown in FIG. 2, the vehicle has a width W(V) and a length L(V), where W(V)<W(S) and L(V)<L(S). When the vehicle occupies a slot, there would be clearance spaces: front clearance C(F), back clearance C(B), left clearance C(L) and right clearance C(R). For ease of calculations in the following examples, it is assumed that a typical passenger vehicle has a width no more than 7 feet and a length no more than 18 feet. If the slot size is selected to be 11 feet wide and 22 feet long, there would be 2 feet of clearance on each side of the vehicle. The vehicle should try to maintain its position at or near the center of the slot during the travel. The clearances would allow for a drift in speed and/or steering direction from individual vehicles and provide sufficient time for correcting the drift. As will be discussed later, these clearances could also be utilized in an emergency, e.g., making space for emergency vehicles, and avoiding obstacles, stalled vehicles, or other accidents.

For example, a 33-foot-wide and one-mile-long stretch of highway would have 720 11-foot by 22-foot slots. That means, at any moment in time, this one mile stretch of highway can hold up to 720 vehicles. If all the vehicles travel at the same speed, e.g., 60 miles per hour (mph), one mile of road would support a maximum of 43,200 vehicles per hour. To see the potential of this approach, for example, take a highway having the length of the US Interstate Highway I-95 (1,925 miles long), it would support over 83 million of vehicles per hour according to an embodiment of the present invention.

All vehicles on the road will have to follow instructions issued by a control system. The control system keeps track of the occupancy of the slots and directs a vehicle to occupy a specific slot at a specific time. The control system transmits commands via a wireless communications system e.g., satellite, cellular network, radio broadcast network, Wi-Fi, etc. Each vehicle is equipped with a communications system for communicating with the control system. In addition, each vehicle includes a processor configured to control the vehicle based on at least one of: commands received from the control system, positional signals from the Global Positioning System (GPS), roadside transponders, as well as proximity sensors on the perimeter of the vehicle. In one embodiment, neighboring vehicles are to maintain at the same speed to avoid collision.

Note that the size of the occupancy data of a highway is relatively small. The occupancy of a slot can be represented by a binary value, e.g., 1=occupied, 0=unoccupied. Using the above slot size numbers, a highway would have 720 slots per mile, and thus the size of the occupancy data would be just 720 bits per mile. Therefore, the system may provide at least real-time local occupancy data to the vehicles in a local area. In one embodiment, vehicles in the area may communicate among themselves to facilitate local controls.

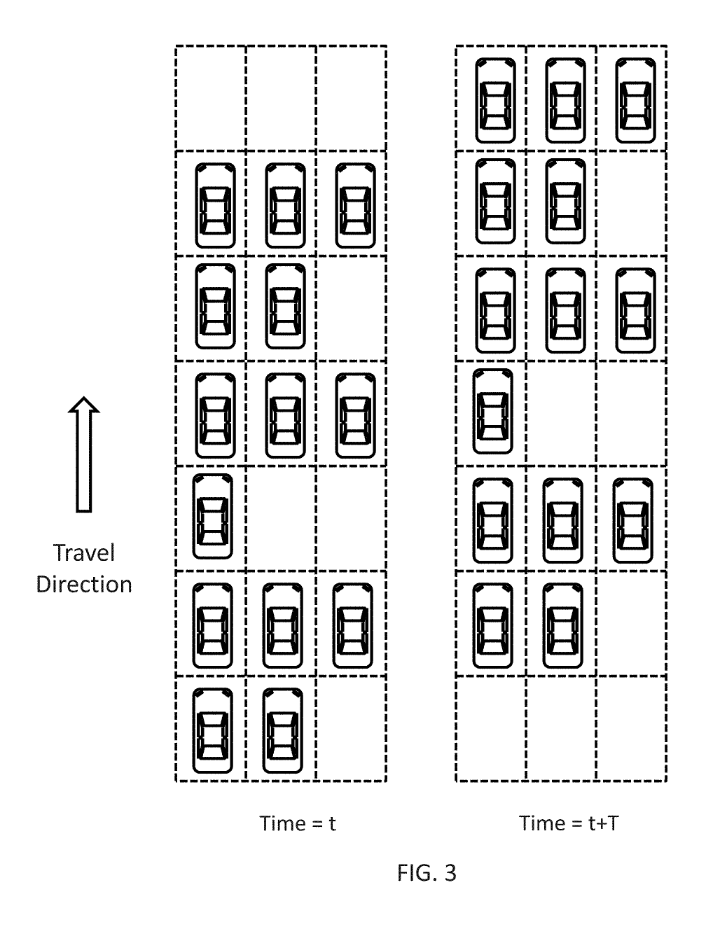

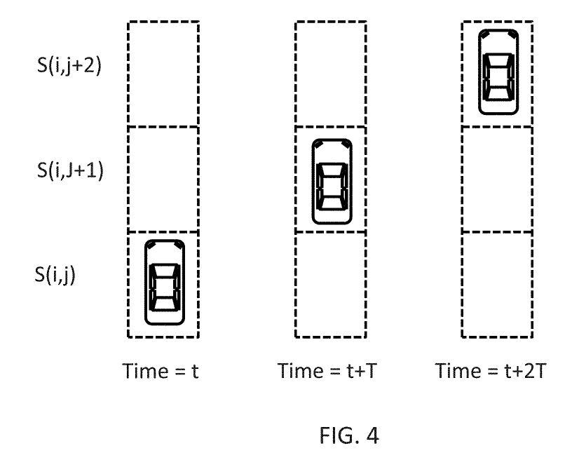

As shown in FIG. 3, the vehicle travels from one slot to another slot in one lane of the highway in a time=slot length/vehicle speed. For example, L(S)=22 feet, and vehicle speed=60 miles per hour, the time to travel one slot along the lane is T=0.25 seconds. Instead of being treated as a continuous variable, time can be divided into timeslots of T duration each, so that time can be treated as an integer multiple of the unit time T. Note that the term “timeslot” refers to a temporal unit and this is to be distinguished from the term “slot” which refers to a spatial unit in the highway. As shown in FIG. 4, if a vehicle occupies slot S(i, j) at time t, then at time=t+T, the vehicle will occupy slot S(i, j+1). In general, at time=t+nT, it can be determined that the vehicle will occupy slot S(i, j+n). Thus, the computational model of the highway system can be treated as a multidimensional matrix of space and time in one embodiment.

It is likely that highways are not always straight, and many have curves. In a curve, the vehicles in an outside lane would have to travel a longer distance than those in the inner lanes. Thus, in order to maintain the relative slot alignment among lanes, the slot sizes in the outside lane at the curves would be made larger than those in the inner lanes, and the vehicle speeds need to be adjusted accordingly so that above slot occupancy per unit time T remains the same. However, in some embodiments to be discussed later, it is not necessary that the slots are aligned among lanes or that the speeds among lanes are the same.

Worldline

When a vehicle travels on the surface of a road, it occupies a spot in a three-dimensional space-time continuum of two spatial dimensions and one temporal dimension. If the vehicle can fly or levitate above the road surface, such as a plane or drone, then it would occupy a spot in a four-dimensional space-time continuum of three spatial dimensions and one temporal dimension. For ease of discussion with respect to the figures, the direction of travel along the lane is the y-axis or vertical direction, and the direction crossing between lanes is the x-axis or horizontal direction.

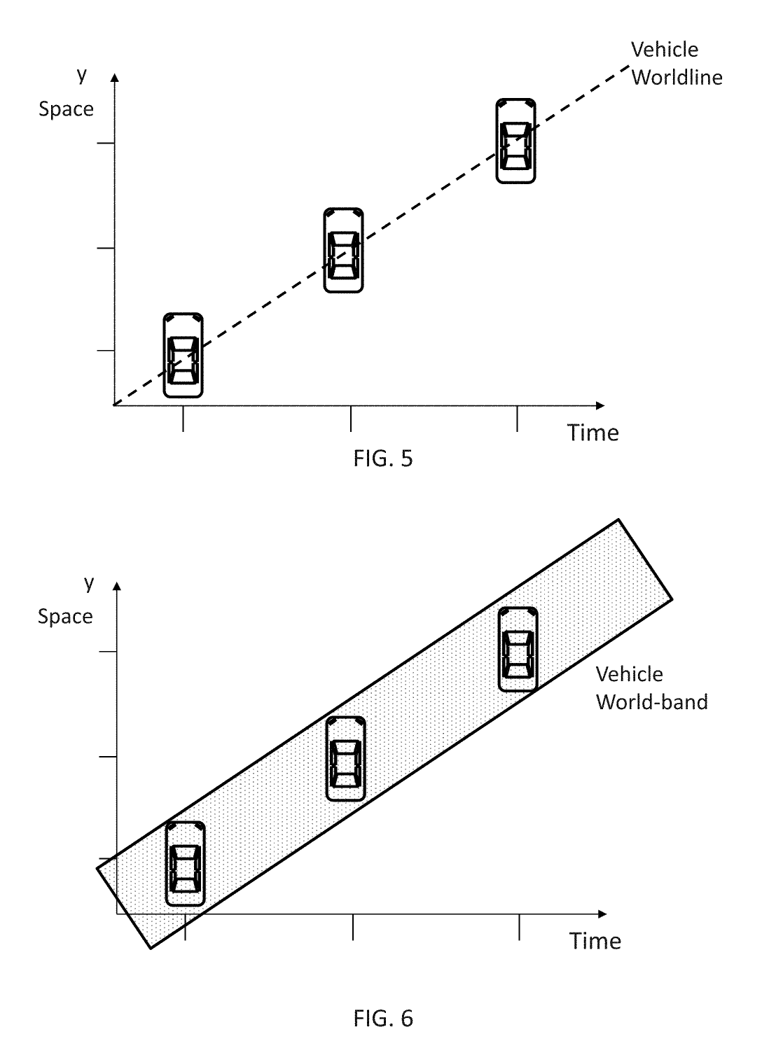

In a simplified version of one spatial dimension (slot space, or lane space) and one temporal dimension, the vehicle's worldline is a plot of the slot occupied by the vehicle versus time in FIG. 5. Since vehicles have dimensions, they are not point particles. Thus, in reality, the path would not be a line, but more like a band. Therefore, their occupancy in space and time should be like a “world-band” as shown in FIG. 6 instead of a worldline. In the case of levitating vehicles, it would be a “world-rod” instead. However, a simple spatial transformation to an external part of the vehicle (e.g., surface of front or rear bumper, edge of side mirrors) would make the collision analysis substantially equivalent to that of a worldline of a point particle.

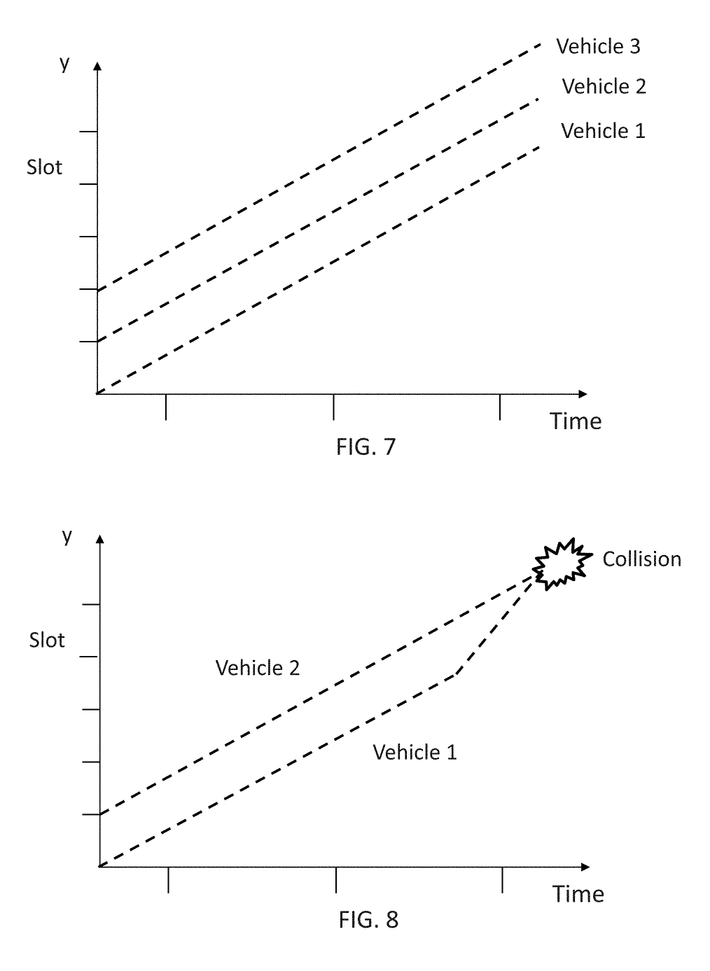

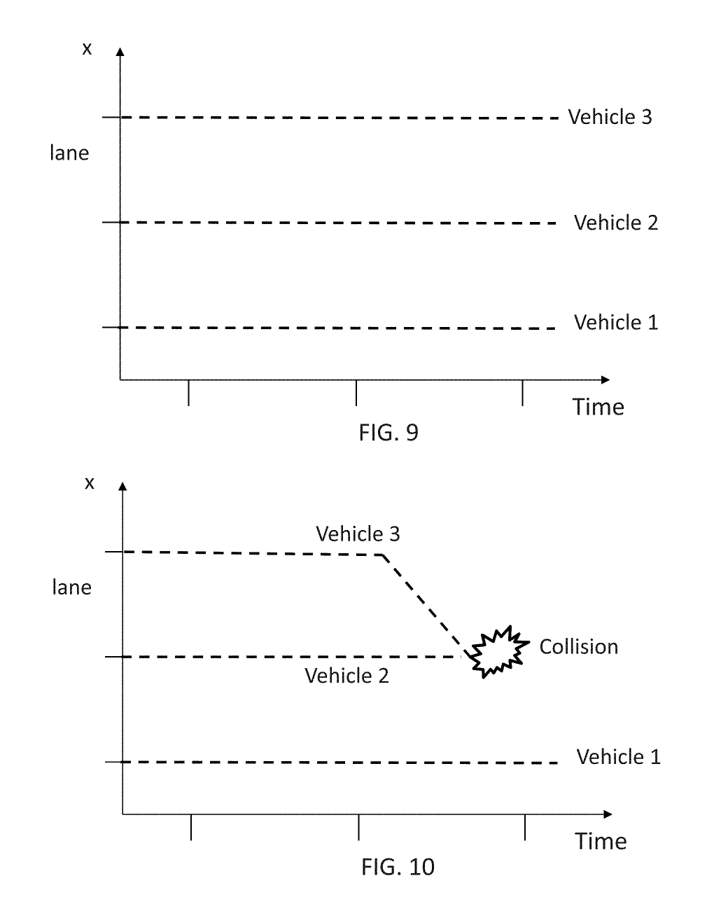

When the worldlines of two vehicles intersect, a collision occurs. For example, FIG. 7 shows three vehicles occupying three consecutive slots and traveling at the same speed. Then, as shown in FIG. 8, the worldlines of vehicle 1 and vehicle 2 intersect, which indicates that vehicle 1 sped up and ran into vehicle 2. In another example, FIG. 9 shows three vehicles occupying three lanes in their respective slots and traveling side-by-side, at the same speed (not shown). Then, as shown in FIG. 10, the worldlines of vehicle 2 and vehicle 3 intersect, which indicates that vehicle 3 crossed lane and ran into vehicle 2. Thus, collision avoidance analysis according to an embodiment is based on whether two worldlines cross, i.e., two vehicles occupy the same slot at the same time. Since the lanes are divided into slots and time is divided into units of T, the worldlines in the space-time continuum can be treated as discrete points in space and time: (slot, timeslot), making the analysis much simpler.

Traveling Slots

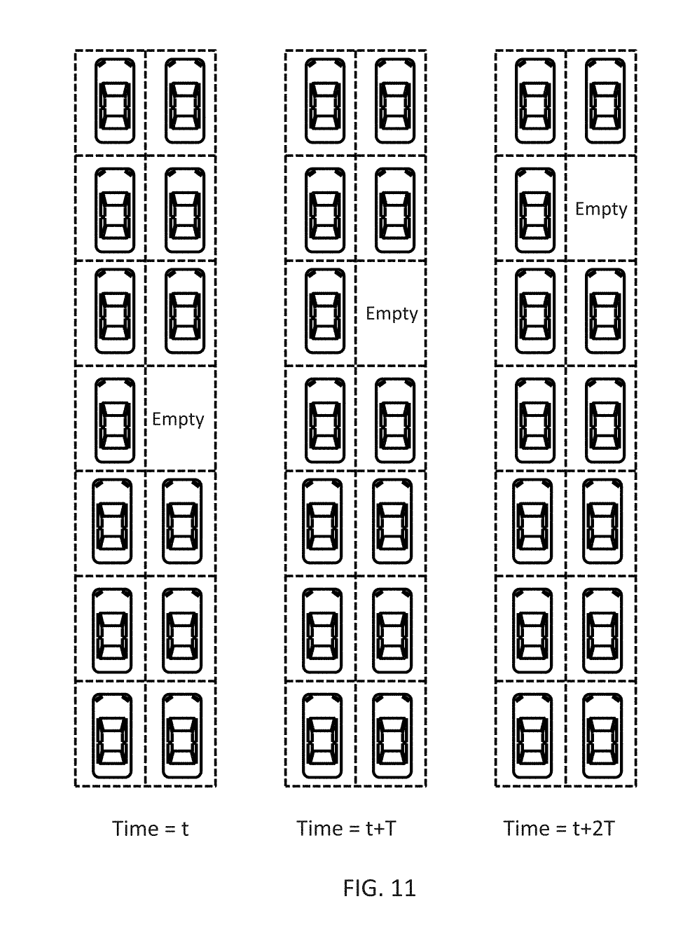

An alternative view of the system is that there is an empty slot that travels along the highway as shown in FIG. 11. Suppose a slot S(i, j) at time t is unoccupied, but the slots before S(i, j−1), S(i, j−2), etc. and the slots after S(i, j+1), S(i, j+2), etc. are occupied. As the vehicles move along, at time=t+T, the slot S(i, j+1) is unoccupied and the slot S(i, j) is occupied. At time=t+2T, the slot S(i, j+2) is unoccupied and the slot S(i, j+1) is occupied. The net effect is that an empty slot travels along the highway, from S(i, j) to S(i, j+1), from S(i, j+1) to S(i, j+2), etc.

The occupancy O[S(i, j), t] of each slot S(i, j) as a function of time t becomes deterministic. O[S(i, j), t]=0, if the slot S(i, j) is not occupied at time t, and O[S(i, j), t]=1, if the slot S(i, j) is occupied at time t. Therefore, a collision avoidance directive would be: O[S(i, j), t]=0 or 1 for all time t. The control system may manage the highway system by controlling each vehicle's slot occupancy and speed.

Getting on the Highway

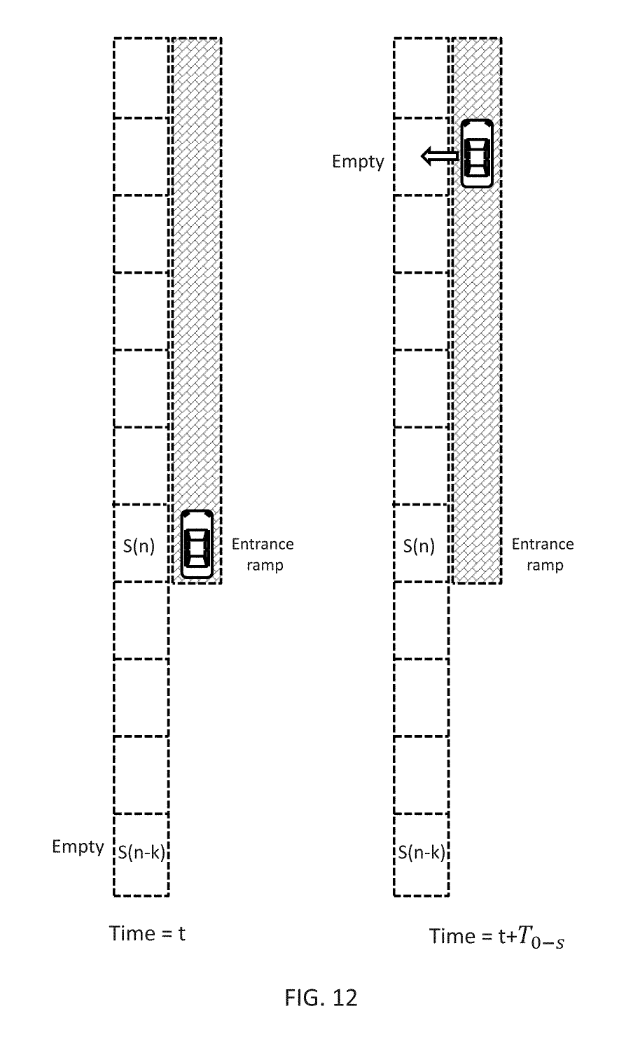

Before entering the highway, the vehicle may be traveling on a local road and is not under the command of the control system. The vehicle communicates with the control system indicating a desired to enter the highway, the control system instructs the vehicle to enter the highway at an entry point identified by a ramp number R(r). As shown in FIG. 12, there is an entrance ramp for getting onto the highway. In the following discussion, the rightmost lane next to the entrance ramp is the lane in focus. The lane number will be omitted from the slot notation, i.e., S(i, j) is simplified to just S(j), j=slot number in the rightmost lane. When a vehicle arrives at the entrance ramp, the slot S(n) immediately next to the vehicle is occupied. However, a slot S(n−k), which is k slots behind, is unoccupied. The vehicle will have to speed up to the travel speed of the highway when it is just next to the unoccupied slot. For simplicity, let's assume the vehicle arrives at the entrance ramp and stops to wait for an unoccupied slot. That is, if the speed of the vehicle is u(t), then u(time of arrival at entrance ramp)=0. For example, the vehicle is capable of a maximum acceleration of 0-60 mph in 6 seconds. Starting from rest, a vehicle would travel a distance of ½aT₀₋ₛ², where a is the acceleration and T₀₋ₛ is the time to reach the desired travel speed s from zero. Here, we assume a constant acceleration. The number of slots traveled by a vehicle on the highway during this time is =T₀₋ₛ/T. In this example, to reach the highway speed of 60 mph in 6 seconds, the vehicle would have traveled a distance of 264 feet. That is, the entrance ramp would have to be at least 264 feet long. During this time, the unoccupied slot would have traveled a distance of 528 feet. Therefore, for the unoccupied slot to arrive at the location where the vehicle has accelerated to the required speed of 60 mph, the unoccupied slot would have to be at least 264 feet (=528 ft-264 ft) behind the slot S(n), which is next to the starting point of the entrance ramp. For a slot length of 22 feet, the unoccupied slot would have to be at least 12 slots behind the slot S(n). In this case, the vehicle should wait for an unoccupied slot S(n−12) to appear before accelerating. In general, the unoccupied slot should be at least a distance of sT₀₋ₛ−uT₀₋ₛ−½aT₀₋ₛ² behind the slot next to the starting point of the entrance ramp.

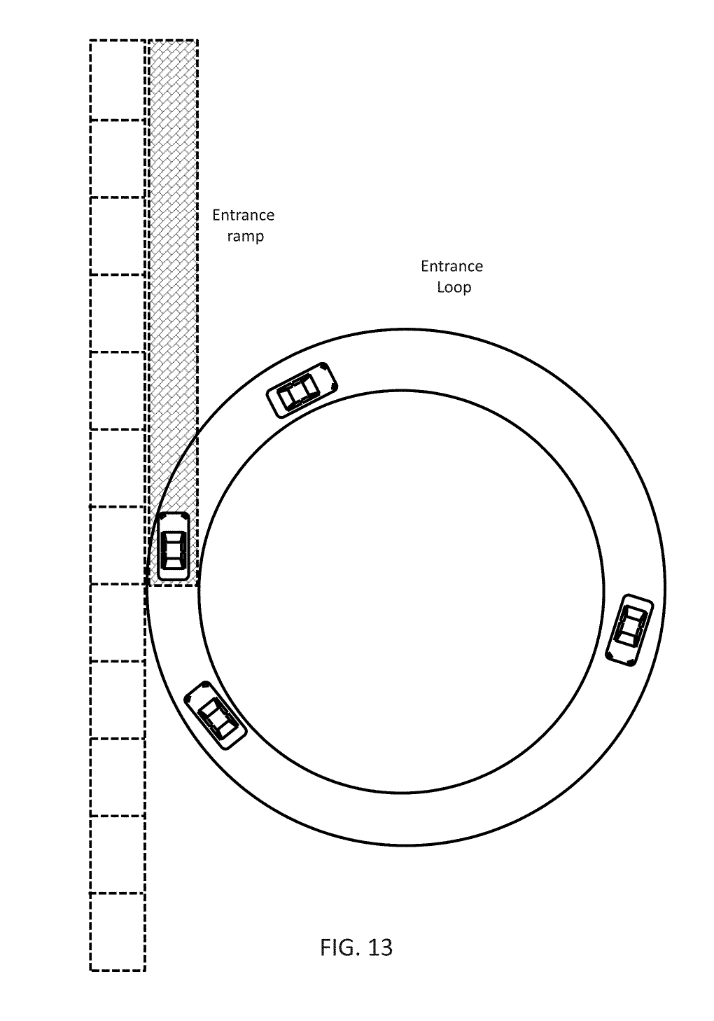

Sometimes it may take a longer time to have an unoccupied slot available. To avoid building up of a queue at the entrance ramp, some vehicles may be denied entry by the control system before they arrive at the entrance ramp. Alternatively, a loop (or buffer) may be built at the entrance ramp as shown in FIG. 13, so that vehicles may circle around the loop until an unoccupied slot available. If the vehicle in the loop travels at a speed equal or close to the lane speed of the highway, the vehicle may enter the highway with no or little further acceleration.

If a vehicle wishes to exit the highway, and if the vehicle is in the lane that is next to an exit ramp, then the vehicle can simply turn to the exit ramp and leave the highway. However, if the vehicle is separated from the exit ramp by one or more lanes, the vehicle has to cross lane one or more times towards the exit ramp. In order not to miss the exit, such action has to take place ahead of time. Since the control system has knowledge of the occupancy of all slots in the highway, it can signal the vehicle to take one or more lane change actions at specific times.

Lane Changing

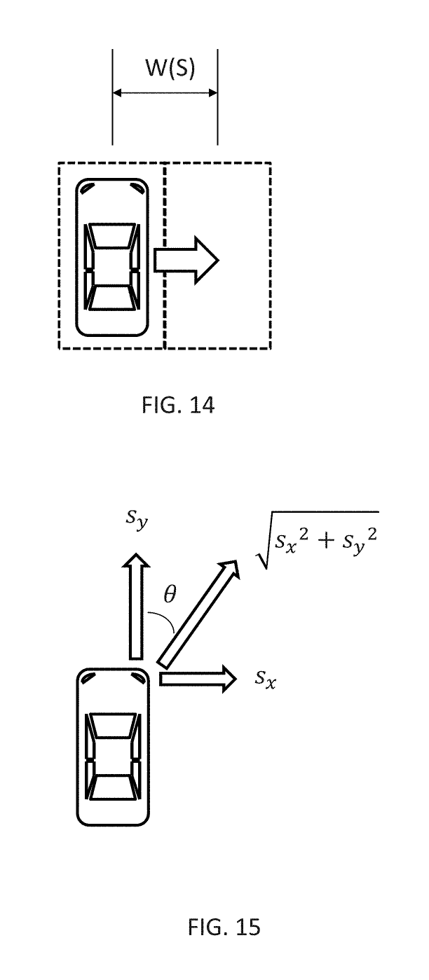

In order for a vehicle to change lane, an unoccupied slot next to the vehicle must be present in an adjacent lane. To complete the lane change, the vehicle will make a lane cross to the unoccupied slot, the distance crossed being equal to the width of the slot W(S), as shown in FIG. 14. The time to make this cross T_{cross}=W(S)/sₓ, where sₓ is the horizontal speed of the vehicle during the cross. Before the cross, the vehicle is traveling at a speed of s_{y} in the vertical direction. As shown in FIG. 15, to make the lane cross, the vehicle will increase the speed to \sqrt{sₓ²+s_{y}²}, and steer the wheel to an angle

$$θ = {tan}^{- 1} ( \frac{{s}_{x}}{{s}_{y}} ) .$$

In the current example, we have W(S)=11 feet. Suppose it is desired to have the cross completed in a time that equals to the unit time T during which the vehicle travel one slot distance of L(S)=22 feet forward with the vertical speed s_{y}=60 mph. In this case, T=0.25 seconds and the average horizontal speed sₓ=30 mph. The vehicle has to turn the wheel by an angle of θ=26.6° towards the unoccupied slot. In the case where the vehicle wishes to cross from lane i to lane i+1, if the vehicle is in slot S(i, j) at time=t, then at time=t+T, the vehicle is in slot S(i+1, j+1). Because of the acceleration and deceleration, an average speed is used here for simplicity. In general, the horizontal speed sₓ(t) of the vehicle will have to satisfy the following condition: ∫₀^{T}^{_{cross}}sₓ (t)dt=W(S), where T_{cross} is desired time to cross a lane of width W(S).

Reference Frame

Sometimes it is more convenient to use different reference frames to analyze the motions in different situations. So far, the reference frame used is the rest frame where the highway is at rest and the vehicles move relative to the highway. In the following discussion, a reference frame will be used in which a specific vehicle is at rest. Motions of other vehicles relative to this specific vehicle will be analyzed.

An advantage of using a reference frame that is traveling at the same speed as the vehicles (rest frame of the vehicle) is that the traffic management of the vehicles resembles a sliding block puzzle, such as the fifteen puzzle invented by Noyes Chapman, and the Rush Hour puzzle invented by Nobuyuki Yoshigahara. In this reference frame, all the vehicles are stationary respect to the reference frame, as they move at the same speed. Moving a designated vehicle to a desired slot (e.g., the desired slot is next to the exit ramp), in the present reference frame, would be like sliding the vehicles horizontally and vertically until the designated vehicle reaches the desired slot within a predetermined number of moves (equivalent to the change in speed of some vehicles in various embodiment discussed in this document). The predetermined number of moves depends on how much time available to reach the exit ramp ahead, the time to make a horizontal move and the time to make a vertical move. If the number of moves exceeds the predetermined number (i.e., exceed the time to reach the exit ramp), then the designated vehicle will miss the exit.

There are AI algorithms developed to solve the fifteen and Rush Hour puzzle. In the present case, the traffic management to be performed by the control system is a collection of special cases of a fifteen puzzle or Rush Hour puzzle, and thus the control system may retrieve and use one of more algorithms saved in a memory for a specific situation.

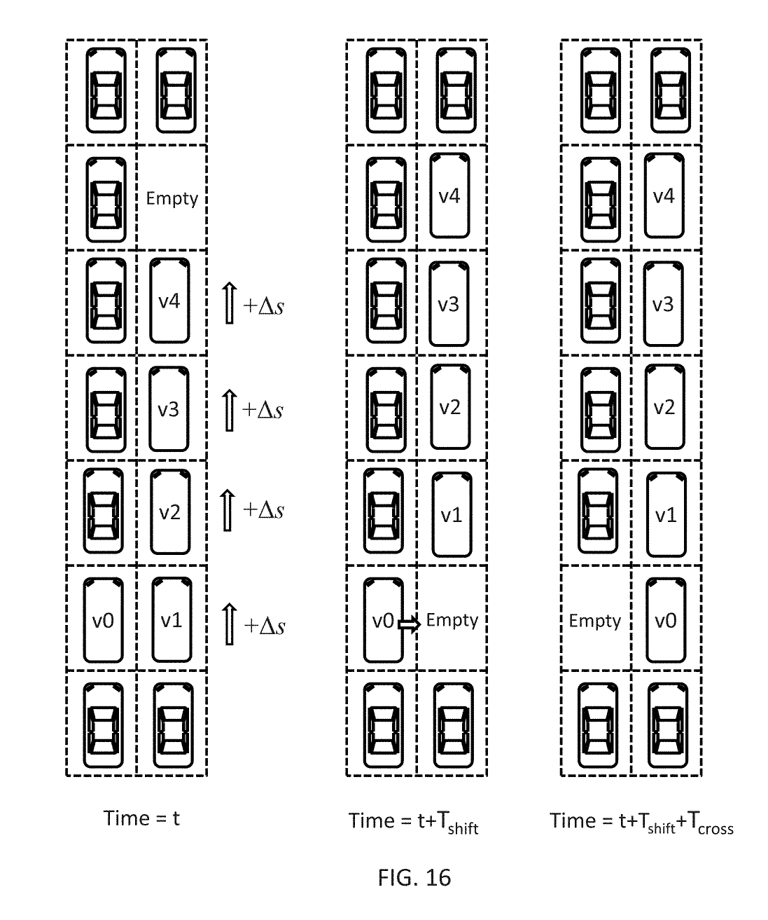

In one embodiment, the analysis becomes a simple sliding block problem for a vehicle to change lane. To change lane there must be a slot available in the target lane. If in the target lane there is no unoccupied slot next to the vehicle, then a shift by one or more vehicles in the target lane is needed to make an unoccupied slot available next to the vehicle, as shown in FIG. 16. Consider that a vehicle V(0) occupying slot S(i, j) at time t wishes to cross to the adjacent lane i+1. However, the slot S(i+1, j) is occupied by vehicle V(1). Suppose n slots ahead (e.g., n=4 in FIG. 16), there is an unoccupied slot S(i+1, j+n), then the control system may instruct vehicles V(1) to V(n) occupying slots S(i+1, j) to S(i+1, j+n−1) respectively, to speed up by Δs until vehicles V(1) to V(n) all advance by one slot relative to the vehicle V(0). The time to make such shift T_{shift}=L(S)/Δs, the length of the slot divided by the average of the change in speed. Again, it is desirable to choose a Δs such that the shift by the vehicles V(1) to V(n) is completed in a time that equals to an integer multiple of the unit time T. For example, if Δs=15 mph, then T_{shift}=1 second=4T. Together with a lane cross by vehicle V(0) at the horizontal speed of sₓ=30 mph, the total time for a lane change by V(0)=T_{shift}+T_{cross}=1.25 seconds=5T. Going back to the rest frame of the highway, it can be seen that in this example, vehicle V(0) occupying slot S(i, j) at time t would occupy slot S(i, j+4) at time=t+4T, and cross to slot S(i+1, j+5) at time=t+5T.

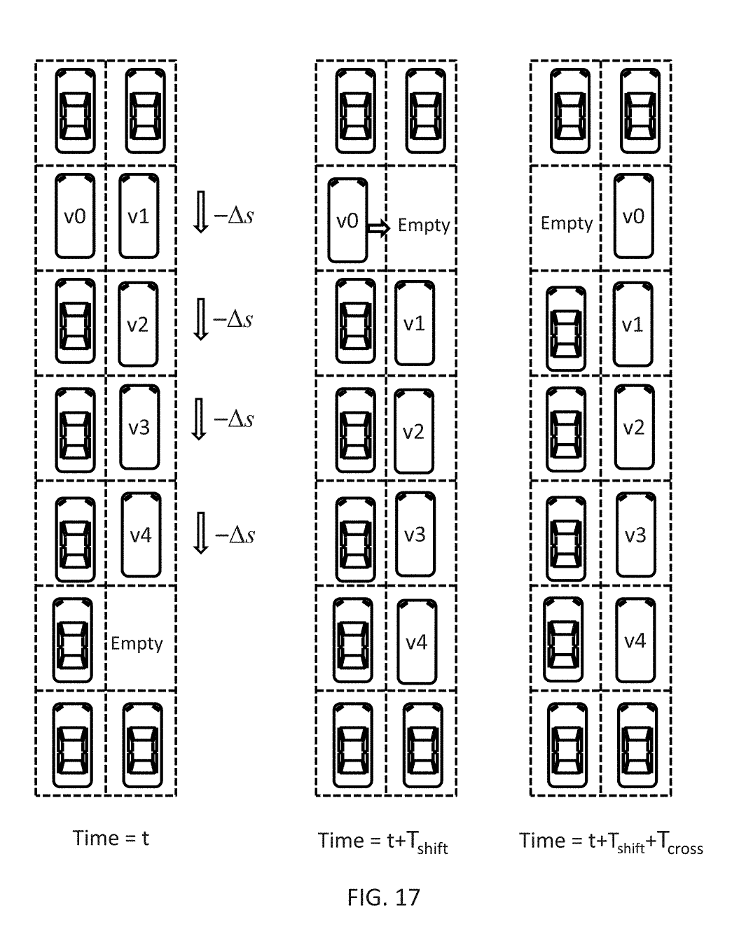

The analysis would be similar for the situation where the unoccupied slot is n=4 slots behind as shown in FIG. 17. That is, the unoccupied slot is S(i+1, j−n). In this case the control system may instruct vehicles V(1) to V(n) occupying slots S(i+1, j) to S(i+1, j−n+1) respectively, to slow down by Δs until vehicles V(1) to V(n) all fall back by one slot relative to the vehicle V(0).

In general, the vertical speed s_{y}(t) of the vehicle will have to satisfy the following condition: ∫₀^{T}^{_{shift}} s_{y} (t)dt=L(S), where T_{shift} is desired time to shift a slot of length L(S). To accomplish a shift of one slot in a time equal an integer multiple of the unit time T, we have: ∫₀^{kT} s_{y} (t)dt=(k±1)L(S), where k is an integer, and the ±1 depends on whether the shift is forward or backward.

Other Vehicles

So far, the vehicles discussed all fit into a slot of width W(S) and length L(S). Sometimes an oversize vehicle may not fit into just one slot. In this case, consecutive slots will be occupied by an oversize vehicle. For example, a cargo truck may occupy three consecutive slots S(i, j), S(i, j+1) and S(i, j+2). To make room for the cargo truck to change lane, for example, three consecutive empty slots must be made available. This can be accomplished by executing the above discussed scheme of shifting forward or backward three times.

For vehicles that are extra wide or carrying wide loads, they may occupy more than one lane. For example, an extra wide vehicle may occupy two adjacent lane slots S(i, j) and S(i+1, j). Similar scheme of lane changing and/or shifting may be used to accommodate these wide vehicles.

Highway Topology

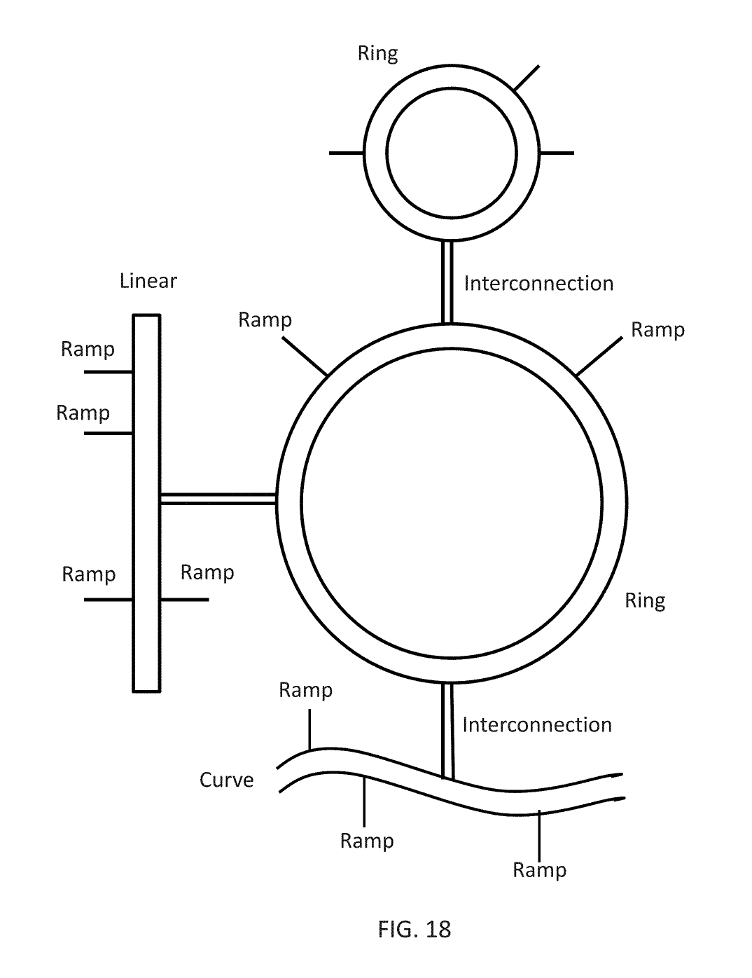

Based on specific transportation requirements, the highway may be configured with a particular topology, such as a line or ring, each with one or more entrance and exit ramps. Furthermore, the highway system may be a combination of connected straight lines, curves and/or rings, as shown in FIG. 18. Different highway systems of same or different topologies may operate in a centralized manner, or independently with cooperative interconnections. With a standardized protocol, when a vehicle goes from one system to another, the control over the vehicle is easily transferred from one system to another. Note that different highway systems may have different travel speeds, as well as slot sizes based on local conditions and specific needs. Before a vehicle enters another highway system, the control system of the to be entered highway will instruct the vehicle to employ the appropriate set of operating parameters for the travelling in the highway.

Lane Speeds

It is not necessary that the lanes have the same speed. For example, lane i may have a travel speed of sᵢ and lane j may have a travel speed of sⱼ. The physical dimensions of the slot are preferably the same among these lanes, i.e., same W(S) and L(S). Thus, the unit time Tᵢ for lane i would be L(S)/sᵢ and unit time Tⱼ for lane j would be L(S)/sⱼ. Furthermore, relative to lane i, the slots in lane j will travel at a speed of sⱼ−sᵢ; and relative to lane j, the slots in lane i will travel at a speed of sᵢ−sⱼ.

If a vehicle is traveling in the first lane and wishes to cross to the second lane, as long as enough empty slots are available, the vehicle in the first lane would have enough time to speed up or slow down to match the speed of the second lane. Empty slots may be made available in either lane. For example, if the current lane has enough empty slots in front of or behind a vehicle, the vehicle may speed up or slow down in its current lane until it reaches the speed of the adjacent lane, and then make the lane crossing. Alternatively, if enough empty slots are available in the adjacent lane, the vehicle may make the lane cross and then speed up or slow down to the speed of the adjacent lane.

An advantage of not having the same speed for all lanes is that it is less likely to generate a resonance frequency over a bridge or other structures due to concerted and periodic contacts of the road surface by the vehicles.

Lane Staggering

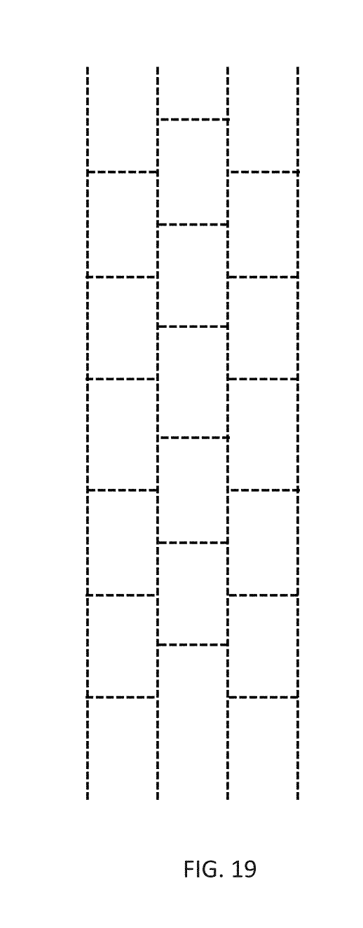

It is not necessary to require the slots in different lanes to line up. The slots may be staggered among the lanes as shown in FIG. 19. In the case of staggering, the lane change can take place sooner because the vehicle does not have to travel a full slot length to line up with the slot in the adjacent lane. For staggering midway, only shifting half a slot length is needed to line up, thus T_{shift}=½ L(S)/Δs. Using the numbers in the above example, Δs=15 mph, we have T_{shift}=0.5 seconds=2T, versus 4T for a full slot shift. Therefore, the time to make a lane change in this case is shortened by 2T.

Merging Lanes

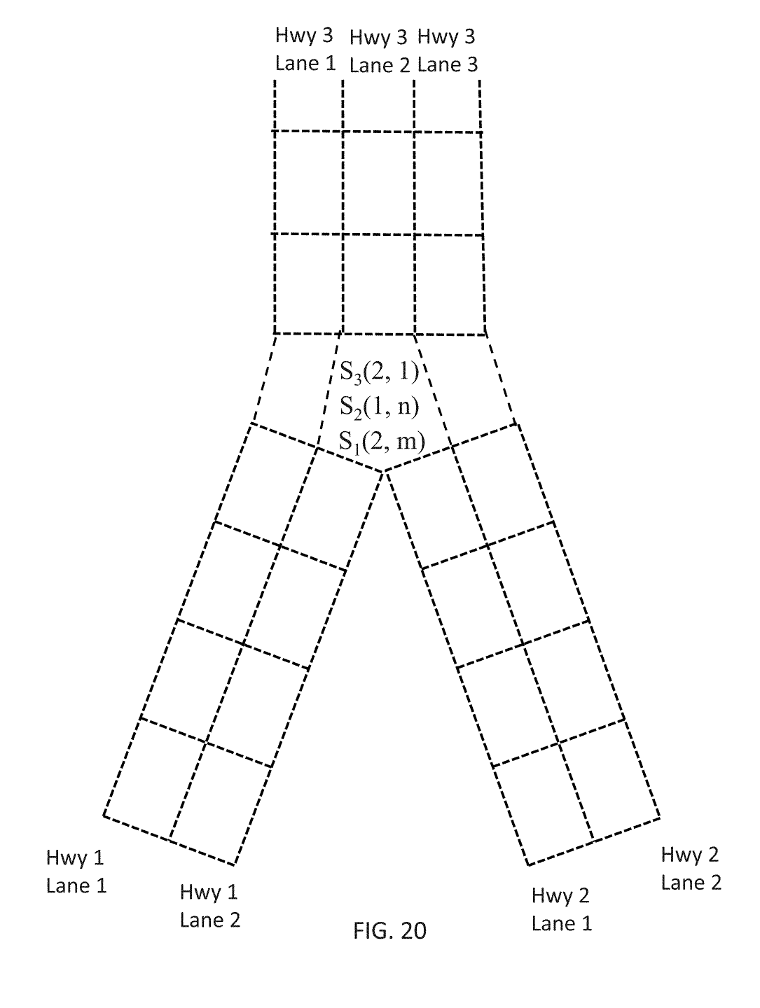

When two highways merges, one or more lane will combine at the merge. The control system will instruct some of the vehicles to move away from the merging lane, so that the common slot at the merge would not be occupied by two vehicles from the two highways at the same time. Consider an example of a first highway merging with a second highway to form a third highway. The first highway has two lanes and have the slots S₁(1, j) and S₁(2, j), j runs from 1 to m, and second highway has two lanes and have the slots S₂(1, j) and S₂(2, j), j runs from 1 to n. The third highway from the merge has three lanes and have slots S₃(1, j), S₃(2, j) and S₃(3, j), j runs from 1 to k. As shown in FIG. 20, the merge occurs at slots S₁(2, m) and S₂(1, n), the merging slots become a common slot that begins as slot S₃(2, 1) in the third highway. Slot S₁(1, m) of the first highway will become slot S₃(1, 1) of the third highway, and Slot S₂(2, n) of the first highway will become slot S₃(3, 1) of the third highway.

Cross Traffic

Although highways usually do not have cross traffic, one advantage of an embodiment of the present invention is that it allows traffic to cross each other at full speed. For example, a first highway going in the North-South direction may intersect with a second highway going in the East-West direction. For ease of discussion here, it is assumed that each highway has one lane. The first highway has slots S₁(j), j=1 to m, and the second highway has slots S₂(j), j=1 to n. The intersection of the first and second highway occurs at slot S₁(p) in the first highway and slot S₂(q) in the second highway. That is, slot S₁(p) overlaps with slot S₂(q). This overlapping results in a common slot to both highway. The control system directs vehicles on both highways such that the slots S₁(p) and S₂(q) cannot be occupied by two vehicles from their respective highways at the same time.

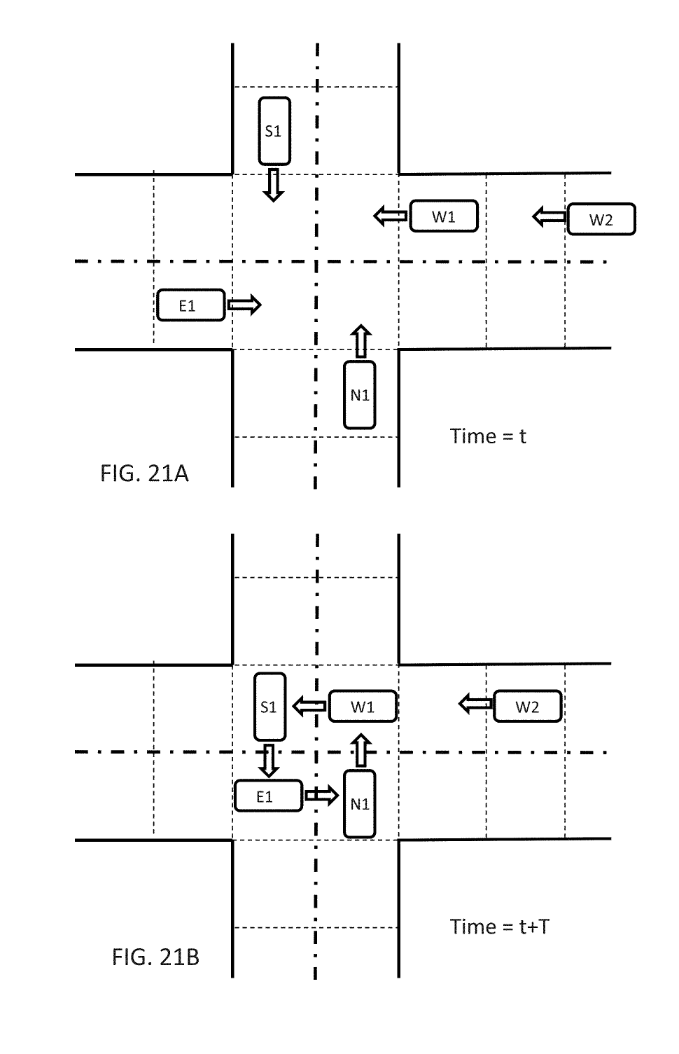

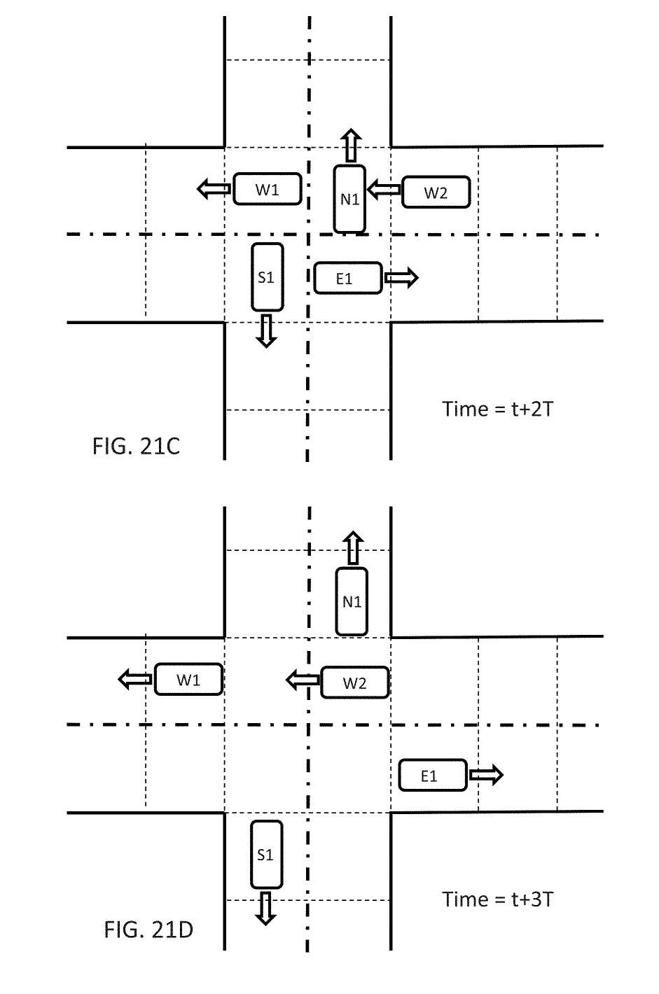

FIGS. 21A-21D illustrate an example implementation of how the traffic may cross at an intersection. There are four common slots at the intersection. Starting anticlockwise from the top right corner, they are: N-E, N-W, S-W and S-E. In this example, we have traffic traveling in North, South, East and West directions. The control system instructs the vehicles to occupy specific slots before the intersection. At time=t, vehicles N1, S1, E1, W1 and W2 are traveling toward the intersection along their respective directions. At time=t+T, N1 occupies the S-E slot, S1 the N-W slot, E1 the S-W slot and W1 the N-E slot. At time=t+2T, N1 occupies the N-E slot, S1 the S-W slot, E1 the S-E slot and W1 the N-W slot. At time=t+3T, N1, S1, E1 and W1 are out of the intersection, and W2 occupies the N-E slot. Note that the vehicles have dimensions, and sufficient clearances around the vehicle in a slot become very important as the vehicles may hit each other mid-way during the transition from one slot to another.

There are situations that may require the vehicles to completely stop at the intersection. For example, the traffic is so heavy that it is impossible to create empty slots like the example illustrated above. Furthermore, if there is not enough clearance around the vehicles, or if there is pedestrian traffic, it would not be safe to implement the above approach. Thus, in one embodiment, the vehicles would stop at specified times to allow the cross traffic or pedestrians to pass through as illustrated in FIG. 22. This would be similar to the existing traffic light system, except that an embodiment of the present invention would have the control system instructing the vehicles in one direction to stop and go simultaneously. That is, the first vehicle through the last vehicle accelerate and decelerate at the same instance, without any delay between vehicles. This solves the problem discussed in the background section that the reaction time accumulates along the vehicle queue, and the embodiment greatly improves the traffic throughput. Note that the vehicles in one direction are controlled by the control system, the cross traffic in another direction is not necessarily be controlled by the control system. If the control system is coupled to some traffic management system for the other directions, like the traditional traffic lights or signals at the intersection to indicate to the cross traffic or pedestrians whether to proceed or stop, then embodiments of the present invention may be integrated with traditional roadways. As discussed above, the traffic throughput of the controlled direction would be higher than that of the other direction because the other direction is still under the traditional traffic management.

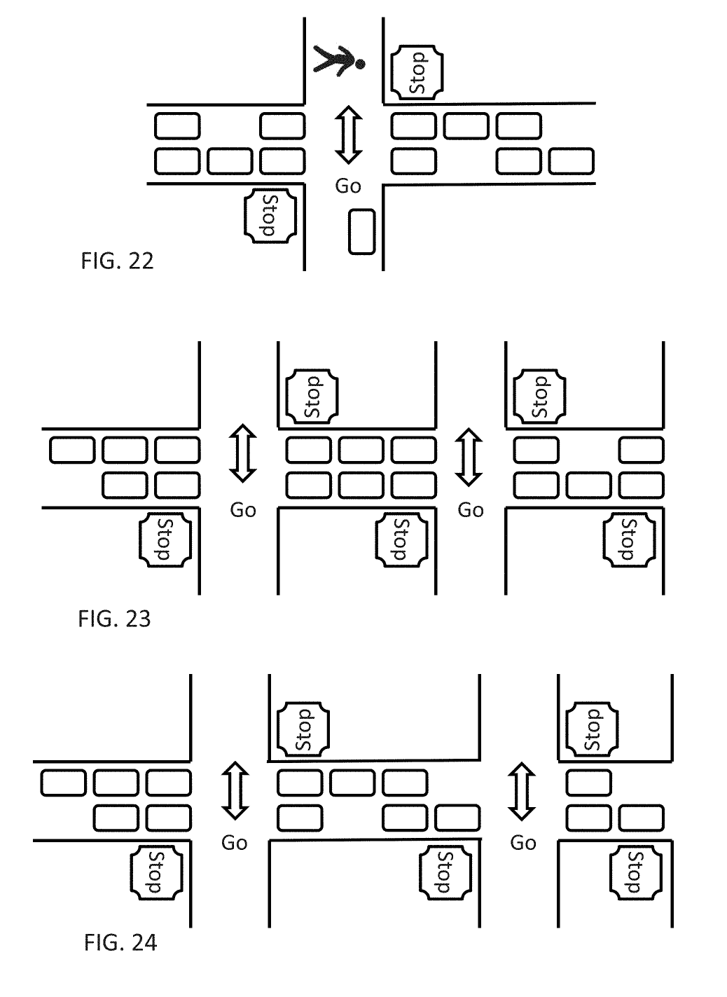

In order to allow the cross traffic to pass through the intersection, the control system will reserve one or more empty slots along the lane, such that when the vehicles stop, the empty slots are at the intersection. If the city blocks are same size, the control system would simply reserve empty slots at a regular interval, as illustrated in FIG. 23. For different city block sizes, the control system would reserve empty slots based on the location of each intersection as illustrated in FIG. 24. Using the above discussed method of shifting one or more consecutive vehicles forward or backward by one or more slots, empty slots may be created at the desired intersections.

Traffic Management

Traffic management of the present highway system resembles the traffic management of a digital data network in the sense that a vehicle may be regarded as a data packet that travels along a data link. However, since each vehicle has its own motion engine to change speed and to cross lanes, there are more options and flexibility available for managing the highway traffic according the embodiment of the present invention.

The communications between the control system and an individual vehicle are very simple. For example, if a vehicle wishes to use the highway, it will communicate with the control system of its identity, origin, destination, and optionally time (i.e., the vehicle may make reservation to use the highway). The control system replies with an entrance ramp number R(r), a slot number S(i, j), speed s and time t of entrance. An example entrance command would look like this: ENTER [V(n), R(r), S(i, j), s, t], where V(n) is the vehicle ID, R(r) identifies the ramp that is near the origin of the vehicle, slot S(i, j) would be the slot the vehicle would immediately occupy upon entry, and t is the time that the vehicle needs to accelerate to attain the travel speed s. Note that V(n) is needed if the control system sends the command by broadcasting. If a private communication is established, it is not necessary to include the vehicle ID V(n) in the command.

An example command to exit the highway may look like this: EXIT [V(n), S(p, q)]. Here the slot S(p, q) is the slot immediately before the vehicle takes the exit ramp to its desired destination. Because of the system being deterministic, no other parameters are needed for the EXIT command. The system knows exactly when the vehicle reaches slot S(p, q). If there is no lane change required, two commands: ENTER [V(n), R(r), S(i, j), s, t] and EXIT [V(n), S(i, q)] would be all that is necessary for controlling the use the highway by the vehicle.

In the case that a lane change is necessary, an example lane change command would look like this: LANE_CHANGE [V(n), S(i, j), i+1, sₓ, t]. Here the system instructs the vehicle to change lane from lane i to the lane i+1 when the vehicle is at slot S(i, j), and sₓ is the cross speed to be used for a duration t. Note that if a default cross speed (e.g., sₓ=½ s) and a default time (T) are used, these parameters are not necessary.

To advance forward or fall back, an example shift command would look like this: SPEED_CHANGE [V(n), S(i, j), Δs, t]. Here the system instructs the vehicle to change its speed by Δs (speed up if Δs is positive, and slow down if Δs is negative) when the vehicle is at slot S(i, j), and the travel speed is changed by Δs for a duration t.

Therefore, a simple set of commands: {ENTER [V(n), R(r), S(i, j), s, t], EXIT [V(n), S(i, j)], LANE_CHANGE [V(n), S(i, j), i+1, sₓ, t], SPEED_CHANGE [V(n), S(i, j), Δs, t]} would be sufficient for normal operations of the highway system. Since the command set is small, and the local slot occupancy data may be made available by the control system to a vehicle, it is conceivable that vehicles may communicate among other vehicles in the vicinity to facilitate local controls.

It is understood that the above command syntax is for illustration purposes only. It is contemplated that equivalent commands, in different programming language or machine code may be used to convey the necessary information.

Traffic Incidents

In an event that a lane is blocked due to an accident, mechanical breakdown, a fallen tree, etc., options are available to mitigate the incident.

In some instances, it may be necessary to stop all traffic in one lane or even all the lanes. The advantage of having the control system in an embodiment of the present invention is that all the vehicles may stop or start at the same time. Therefore, when an accident happens, all vehicles stop at the same time, then when the obstacle is cleared, all the vehicles start again at the same time. So, the delay would only be limited to the time to remove the obstacle plus the deceleration and acceleration times. Comparing to the delays due to the above noted accordion effect in the background section, this approach may result in a much shorter delay overall.

Note that there is no technical reason not to have the vehicles stop and then go in the reverse direction so that vehicles may exit at an available exit ramp. This approach is particularly useful when the highway has a ring topology (see FIG. 17). Suppose a major accident completely blocks all lanes in the highway, in order to get to the destination beyond the accident, the vehicles may go in the reverse direction and get to the destination via the unbroken part of the ring. In this case, the delay would be the deceleration time to stop and acceleration time to go in reverse, plus the travel time of any additional distance.

Emergency Vehicle

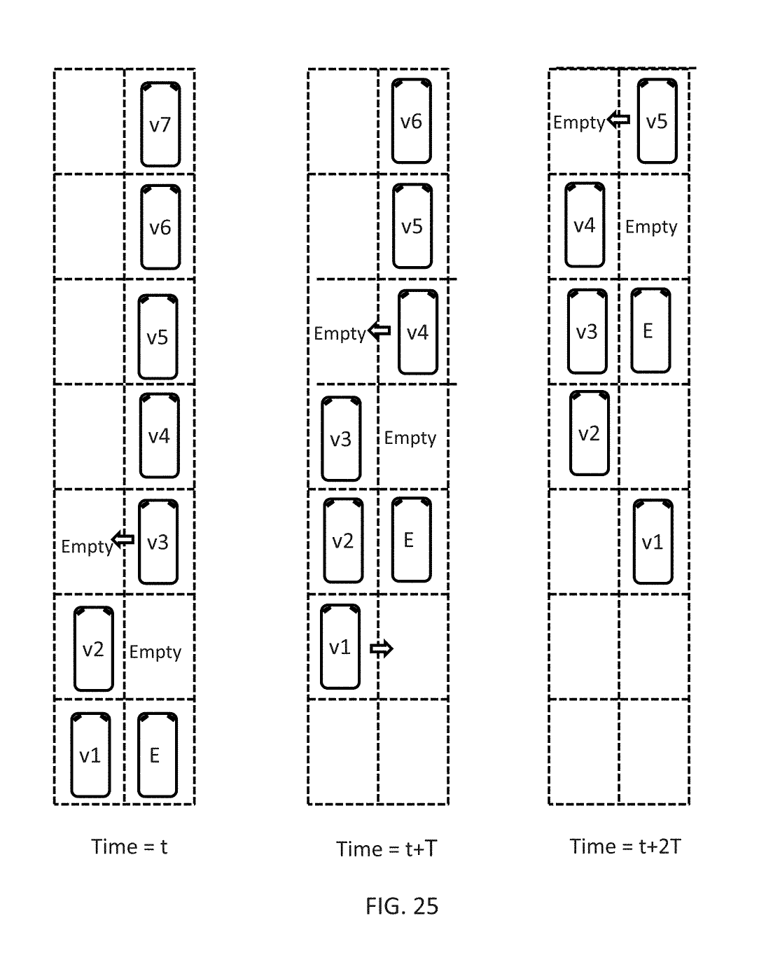

In case of an emergency, slots must be made available for emergency vehicles, such as police car, ambulance, fire trucks, etc. In many cases, these vehicles require to travel at a higher speed in order to get to the destination as soon as possible. For ease of discussion, it is assumed that an emergency vehicle will travel at a speed twice as the normal traffic. For example, if normal traffic speed is 60 mph, the emergency vehicle travels at a speed of 120 mph. That means the emergency vehicle would travel a two-slot distance during a unit time T. The control system will have to make two consecutive slots available for the emergency vehicle. To accomplish this, the control system will instruct the vehicles to make lane change so that at least one empty slot is always in front of the emergency vehicle as shown in FIG. 25. To avoid the emergency vehicle getting too close to the vehicle changing lane in front of the emergency vehicle, the horizontal speed for lane changing can be increased. After being passed by the emergency vehicle, the yielding vehicle, e.g., v1 may change back to its original lane.

As already discussed above, the slot size is larger than the vehicle size, thus there are clearances around the vehicle. The system may take advantage of these clearances for squeezing the spaces between the vehicles to make room for emergency or other purposes.

As already shown in FIG. 2, each slot has clearances C(F), C(B), C(L) and C(R) around a vehicle. To make room for emergency vehicles, the control system may temporarily decrease one or more of the clearances, effectively making the slot size smaller. In one embodiment, n vehicles are instructed to occupy a slot of smaller size to make one empty slot available. Thus, originally n vehicles occupying n slots may now occupy only n−1 slots. The length of the slot L(S) is changed to L′(S) such that (n−1) L(S)=n L′(S). Here, the value of n depends of the values of clearances C(F) and C(B). In another embodiment, m vehicles are instructed to occupy a slot of smaller size to make one empty lane available. Thus, originally m vehicles occupying m lanes may now occupy only m−1 lanes. The width of the slot W(S) is changed to W′(S) such that (m−1) W(S)=m W′(S). Here, the value of m depends of the values of clearances C(L) and C(R). Since there are fewer lanes to work with, it is possible that the condition (m−1) W(S)=m W′(S) cannot be satisfied. That is, it may not be possible to empty out a full lane width of space by narrowing the width of the slots. However, the system only needs to provide sufficient space for the emergency vehicle to pass through. Thus, if the width of space required for the vehicle to pass through is W(E), then slot width and clearances in the highway system can be engineered to satisfy the condition m (W(S)−W′(S))=W(E). For example, if the left lane is blocked in a three lane highway having the above example dimensions, the system may direct the vehicles in the right lane to move to the right by 2 feet, the vehicles in the center lane to move to the right by 5 feet, and the vehicles in the left lane to move to the right by 8 feet simultaneously. This would have at least one foot of clearance between the vehicles, and this would leave at least 10 feet of clearance to get around the obstacle in the left lane.

Admission Control

Theoretically, all slots may be occupied for full capacity. Practically, empty slots are needed in order for vehicles to enter the highway, change lane and shift forward or backward. Therefore, the system should control the number of vehicles traveling on the highway to ensure that sufficient empty slots are available throughout the highway for traffic operations, management and emergencies. When the slot occupancy rate has reached above a threshold, the system would deny entry of new traffic until the occupancy rate has dropped below the threshold as vehicles exit the highway at their respective destinations. Denied traffic may wait at the entrance ramp or loop, or alternatively, travel on local streets and attempt to get on the highway at the next entrance ramp further along the highway. For vehicles on the highway that are not yet near their destination, the control system may instruct them to change lane away from the lane adjacent to the entrance ramp, so that more empty slots are available for traffic entry.

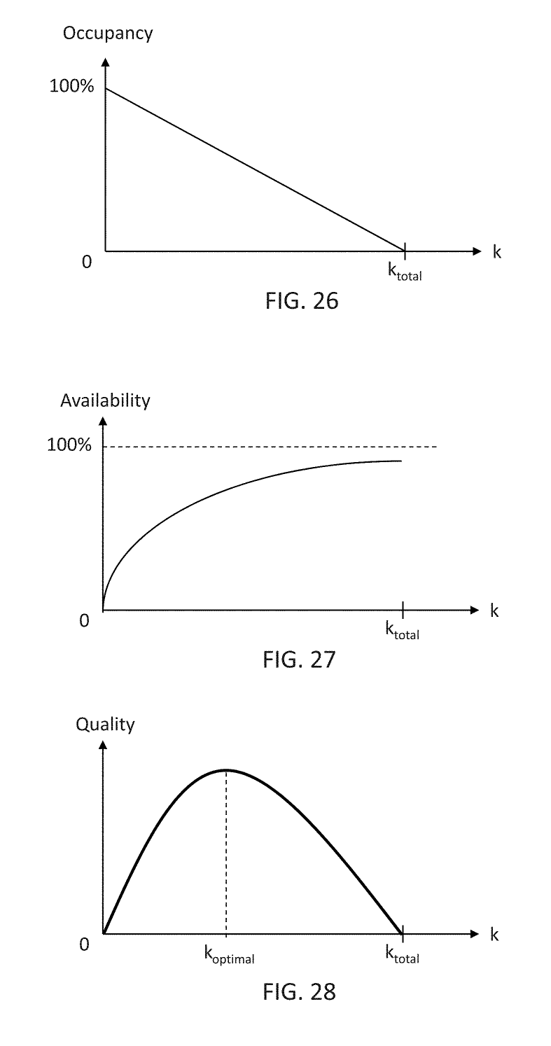

In one embodiment, the following quality model is used to determine the optimal number of available slots at each of the entrance ramp. One example quality factor is the occupancy rate of the slots in the lane to which traffic may enter. If the lane has a total of kₜₒₜₐₗ slots, of which k empty slots are available for traffic entering the highway, the occupancy rate as a function of k is plotted in FIG. 26. Since k is an integer, the graph shows the trendline joining the discrete points. As can be seen from FIG. 26, the occupancy rate Occupancy(k) goes from 100% to 0% as k goes from 0 to kₜₒₜₐₗ. FIG. 27 is a trendline representing the availability of a slot for traffic entry. As can be seen from FIG. 27, the availability of a slot for traffic entry Availability(k) goes from 0% approaching 100% as k goes from 0 to kₜₒₜₐₗ. Note that the Availability(k) may not get to 100% as there is a finite probability that the number of entering traffic exceeds the total number of slots kₜₒₜₐₗ. Two simple quality models according to an embodiment are (1) product of the occupancy rate and availability: Q(k)=Occupancy(k)×Availability(k), and (2) a weighted sum of the occupancy rate and availability: Q(k)=w₁ Occupancy(k)+w₂ Availability(k), where w₁ and w₂ are the respective weights of the occupancy rate and availability. FIG. 28 shows the optimal number of available slots kₒₚₜᵢₘₐₗ for traffic entry based on the quality model (1) according to an embodiment.

Hybrid Highway

From the economical as well as practical point of view, it may be desirable to have a highway system for autonomous vehicle according to one of the above embodiments (designated as a managed highway system) alongside with a traditional highway system (designated as an unmanaged highway system). For example, in a stretch of multi-lane highway, one or more lanes may be designated as a managed highway system, in which the vehicles are managed by a control system, and next to it, one or more lanes may be designated for an unmanaged highway system, in which vehicles negotiate the use of the road among themselves. In one embodiment, vehicles may enter or exit between the two highway systems under the direction of a control system in the autonomous vehicle highway system. The additional operations and management activities to consider are getting on and off between the two highway systems.

If a vehicle traveling on the managed highway needs to get on to the unmanaged highway, the control system directs the vehicle to the lane next to a lane of the unmanaged highway. As soon as there is enough space for the vehicle to change lane from the managed highway to the unmanaged highway, the control system releases the control over the vehicle, and the vehicle proceed to move to the lane of the unmanaged highway. In one embodiment, a blind spot detection system on the vehicle may be used to detect when the vehicle may have an opportunity to change lane and would trigger the release of the vehicle from the control system. In another embodiment, the person in the vehicle may use the rearview mirror and/or side mirror to determine the opportunity to change lane and initiate the release from the control system. It is contemplated that other proximity sensors and/or other traffic monitoring systems may also be used to find such opportunity in other embodiments.

If a vehicle traveling on an unmanaged highway wishes to enter the managed highway, the vehicle will signal the control system and request entry. The vehicle will be denied entry if the occupancy rate is above a threshold or the vehicle does not meet the minimum requirements necessary to operate in the managed highway system, such as communicate protocol, size, speed, power, and sensing abilities, etc. When the control system receives a request to enter the managed highway, the control system assigns an empty slot in a lane next to the unmanaged highway for traffic entry. The empty slot will be reserved for the vehicle for a predetermined time period, and the vehicle will have to navigate in the unmanaged highway to get to the empty slot within the time period. Similar to the above discussed process of vehicle entering from an entry ramp, the vehicle will have to enter the empty slot with a speed equal to the travel speed of managed highway.

Note that in the unmanaged highway, there is no central coordination, and the vehicles must negotiate usage of the highway among themselves. Therefore, it is possible that the vehicle may not be able to get to the empty slot within the predetermined time period due to the traffic condition in the unmanaged highway. For example, the prevailing travel speeds in the unmanaged highway may be too high or too low, making it unsafe for the vehicle to maintain or achieve the required speed before entry. It is also possible that another vehicle is traveling right next to the empty slot with the same travel speed of the managed highway, and thus blocking the entry. If the vehicle misses the entry opportunity, it may request entry again. Depending on the occupancy of the managed highway, the control system may increase the probability of success by allocating a longer time period, multiple time periods, or multiple empty slots for vehicle entries from the unmanaged highway.

As autonomous vehicles are becoming ubiquitous, the highway system and its operation according to various embodiments of the present invention fulfill a long-felt need for easing traffic congestion by taking the human factor out of driving. In addition to saving time and increasing traffic throughput, safety, lowering energy consumption and limiting greenhouse gases emission are some of the benefits of employing a system or method disclosed above.

Although the present disclosure illustrates some embodiments of the present invention based on autonomous vehicle on a highway, it is contemplated that the system and method discussed above may be extended to air or sea traffic in an equivalent system. In case of air traffic, in addition to multiple lanes and slots, there would be multiple levels corresponding to different heights above ground. Similar situation exists for submarine traffic where the multiple levels correspond to different depths below water. Furthermore, the above embodiments are also applicable to devices equipped with ambulatory means, such as robots walking on an equivalent roadway system.

This disclosure describes the best mode or modes of practicing the invention as presently contemplated. While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

Furthermore, the functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof.

What is claimed is:

1. A highway system comprising:
a stretch of highway that comprises one or more lanes, and each lane being divided into a plurality of fixed size slots;
a plurality of vehicles traveling on the highway at a system specified speed; and
a control system configured to control the plurality of vehicles by sending commands to the plurality of vehicles via a wireless communication system;
wherein the control system is configured to divide time into timeslots based on the system specified speed and the size of the slots, such that each vehicle is assigned to occupy a slot during a timeslot;
wherein each of the plurality of vehicles comprises a processor configured to receive a command from the control system and to control its associated vehicle according to the command.

2. The highway system of claim 1, wherein the control system sends a command to instruct one or more vehicles in a lane to speed up or slow down for a predetermined time period such that a specified slot in the lane is vacated.

3. The highway system of claim 2, wherein the control system sends a command to instruct a vehicle occupying a corresponding slot in an adjacent lane to occupy the vacated specified slot.

4. The highway system of claim 1, wherein the highway further comprises an entry point and an exit point;
wherein the control system is further configured to send a command to instruct an entering vehicle to enter the highway at the entry point at a specified entry time, and to send a command to instruct one or more vehicles in a lane to speed up or slow down for a predetermined time period such that a slot next to the entry point in the lane is vacated for the entering vehicle at the specified entry time; and
wherein the control system is further configured to send a command to instruct an exiting vehicle to exit the highway at the exit point at a specified exit time, and to send a command to instruct one or more vehicles in one or more lanes to speed up or slow down for a predetermined time period such that one or more slots in one or more respective lanes are vacated allowing the exiting vehicle to reach the vacated slot in a lane next to the exit point.

5. The highway system of claim 1, wherein the highway comprises two lanes that merge or cross at a slot common to both lanes, and the control system is further configured to send a command to one or more vehicles in the two lanes to change to another lane such that the common slot is occupied by no more than one vehicle from the two lanes at any given time.

6. The highway system of claim 1, wherein the highway intersects with a road at an intersection, the intersection comprising one or more slots, and the control system is further configured to send a command to instruct a plurality of vehicles to stop at a specified time, and to instruct one or more vehicles in a lane to speed up or slow down for a predetermined time period such that the one or more slots at the intersection are not occupied when the plurality of vehicles stop at the specified time.

7. The highway system of claim 1, wherein the control system is further configured to change the slot size of one or more slots in one or more lanes and to send a command to instruct one or more vehicles to occupy their respective size-changed slots.

8. The highway system of claim 1, wherein the control system is further configured to send a command to instruct one or more vehicles to travel in a reverse direction.

9. The highway system of claim 8, wherein the highway comprises a ring topology.

10. The highway system of claim 1, wherein the control system is further configured to allow traffic entry and exit between the highway system and an unmanaged highway system by assuming control of entering vehicles from the unmanaged highway system and releasing control of exiting vehicles to the unmanaged highway system.

11. A method of managing a highway system that comprises one or more lanes, the method comprising:
dividing each of the one or more lanes into a plurality of fixed size slots;
controlling a plurality of vehicles traveling on the highway at a system specified speed; and
dividing a system time into timeslots based on the system specified speed and the size of the slots, such that each vehicle is assigned to occupy a slot in the highway during a timeslot;
transmitting a control command to a processor in each of the plurality of vehicles via a wireless communication system so that the processor controls its associated vehicle according to the command.

12. The method of claim 11, further comprising sending a command to instruct one or more vehicles in a lane to speed up or slow down for a predetermined time period such that a specified slot in the lane is vacated.

13. The method of claim 12, further comprising sending a command to instruct a vehicle occupying a corresponding slot in an adjacent lane to occupy the vacated specified slot.

14. The method of claim 11, wherein the highway further comprises an entry point and an exit point; the method further comprising:
sending a command to instruct an entering vehicle to enter the highway at the entry point at a specified entry time, and sending a command to instruct one or more vehicles in a lane to speed up or slow down for a predetermined time period such that a slot next to the entry point in the lane is vacated for the entering vehicle at the specified entry time; and
sending a command to instruct an exiting vehicle to exit the highway at the exit point at a specified exit time, and sending a command to instruct one or more vehicles in one or more lanes to speed up or slow down for a predetermined time period such that one or more slots in one or more respective lanes are vacated allowing the exiting vehicle to reach the vacated slot in a lane next to the exit point.

15. The method of claim 11, wherein the highway comprises two lanes that merge or cross at a slot common to both lanes, and the method further comprising sending a command to instruct one or more vehicles on the two lanes to change to another lane such that the common slot is occupied by no more than one vehicle from the two lanes at any given time.

16. The method of claim 11, wherein the highway intersects with a road at an intersection, the intersection comprising one or more slots, and the method further comprising sending a command to instruct a plurality of vehicles to stop at a specified time, and to instruct one or more vehicles in a lane to speed up or slow down for a predetermined time period such that the one or more slots at the intersection are not occupied when the plurality of vehicles stop at the specified time.

17. The method of claim 11, further comprising changing the slot size of one or more slots in one or more lanes and sending a command to one or more vehicles to instruct the one or more vehicles to occupy their respective size-changed slots.

18. The method of claim 11, further comprising sending a command to one or more vehicles instructing the one or more vehicles to travel in a reverse direction.

19. The method of claim 18, wherein the highway comprises a ring topology.

20. The method of claim 11, further comprising allowing traffic entry and exit between the highway system and an unmanaged highway system by assuming control of entering vehicles from the unmanaged highway system and releasing control of exiting vehicles to the unmanaged highway system.
